(19) United States
(12) Patent Application Publication
(10) Pub. No.: US 2009/0231767 A1
(43) Pub. Date: Sep. 17, 2009

(54) Electronic device with electricity leakage protection

(75) Inventor: Li-Wei Lin, Yilan County (TW)

Correspondence Address: SCHWEGMAN, LUNDBERG & WOESSNER, P.A., P.O. BOX 2938, MINNEAPOLIS, MN, 55402, US

(73) Assignee: Top Victory Investments Limited

(21) Appl. No.: 12/157,340

(22) Filed: Jun. 10, 2008

(30) Foreign Application Priority Data
Mar. 13, 2008 (TW) 097204308

(51) Int. Cl. H02H 9/08

(52) U.S. Cl. 361/58

(57) ABSTRACT

An electronic device with electricity leakage protection includes a ground wire, a system ground unit, and a protective element connected electrically at one end to the ground wire and at another end to the system ground unit. The protective element limits flow of electrical current through the ground wire into the system ground unit.

### CROSS-REFERENCE TO RELATED APPLICATION

This application claims priority of Taiwanese application no. 97204308, filed on Mar. 13, 2008.

### BACKGROUND OF THE INVENTION

1. Field of the Invention

This invention relates to an electronic device, more particularly to an electronic device with electricity leakage protection.

2. Description of the Related Art

Differences in ground potential between electrically connected electronic devices can create a resistive path between grounds through which hazardous leakage current can flow. Such differences in ground potential often emerge as a result of characteristics and conditions unique to each ground path, and frequently manifest between a power ground of the electronic device and a signal ground of a peripheral device, such as a power ground of a computer and a signal ground of a modem. Under ground fault conditions, electrical current can flow through the power ground into the signal ground, overheating wiring of the signal ground and presenting a shock hazard.

FIG. 1 illustrates one prior art method for mitigating the aforementioned hazards associated with differences in ground potential. In this method, a ground wire 82 of an electronic device 81 and a signal ground wire 83 of a peripheral device (not shown) are isolated from one another by means of an isolating component 84 (such as rubber, plastic, an isolating capacitor, etc.). Although a broken circuit state between the ground wire 82 and the signal ground wire 83 is effectively achieved, electrical current flow into the ground wire 82 may still pose a safety threat.

FIG. 2 illustrates another prior art method for mitigating the aforementioned hazards associated with differences in ground potential, in which the ground wire inside a conventional plug for an electronic device is replaced with a floating ground 91. Although this method prevents electrical connection between grounds, the ground wire 91 may still carry a charge, and moreover lacks an outer covering. Consequently, this method also poses safety hazards.

### SUMMARY OF THE INVENTION

Therefore, the object of the present invention is to provide an electronic device with electricity leakage protection.

According to this invention, the electronic device comprises a ground wire, a system ground unit, and a protective element connected electrically at one end to the ground wire and at another end to the system ground unit. The protective element limits flow of electrical current through the ground wire into the system ground unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional method for preventing electricity leakage;

FIG. 2 is a schematic diagram of another conventional method for preventing electricity leakage;

FIG. 3 is a schematic diagram of a first preferred embodiment of an electronic device with electricity leakage protection according to the present invention;

FIG. 4 is a schematic diagram of a second preferred embodiment of an electronic device with electricity leakage protection according to the present invention; and

FIG. 5 is a schematic diagram of a third preferred embodiment of an electronic device with electricity leakage protection according to the present invention.

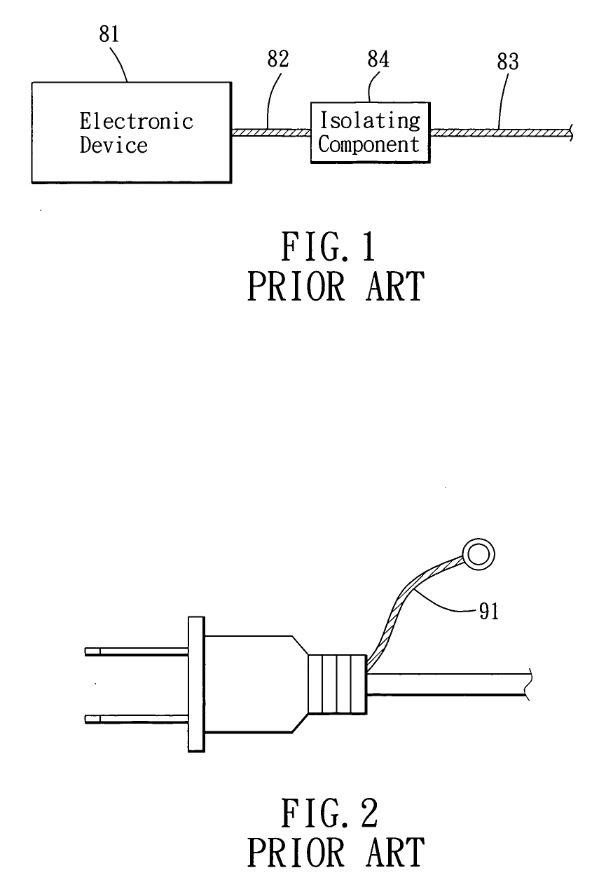

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

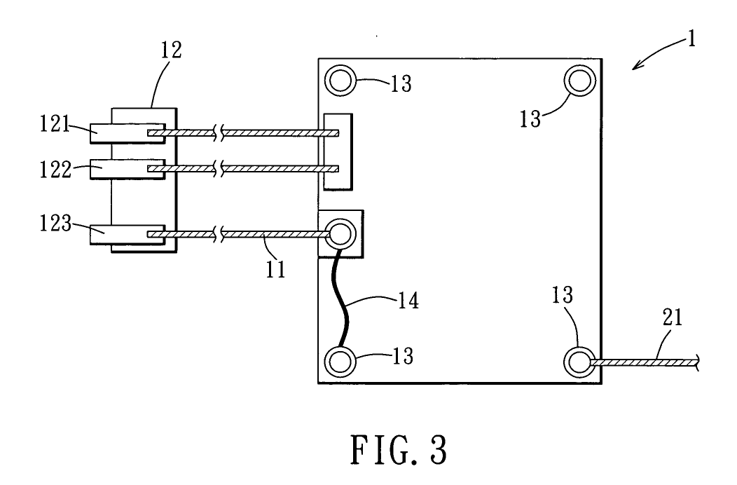

Referring to FIG. 3, a first preferred embodiment of an electronic device 1 with electricity leakage protection according to this invention is shown to comprise a ground wire 11, a plug 12, a system ground unit having terminals 13, and a protective element 14. In this embodiment, the plug 12 is provided with a positive polarity prong 121, a negative polarity prong 122, and a ground prong 123, so as to correspond to a positive polarity insertion aperture, a negative polarity insertion aperture, and a ground wire insertion aperture of an outlet having a three-wire power distribution scheme (not shown). One end of the ground wire 11 is connected to the ground prong 123 of the plug 12, and another end is connected to the protective element 14, which in this embodiment is a safety fuse. The protective element 14 is further connected to one terminal 13 of the system ground unit.

Preferably, the system ground unit of the electronic device 1 with electricity leakage protection is adapted for electrical connection to a signal ground wire 21 of an external device (not shown). The electronic device 1 with electricity leakage protection of this embodiment could therefore be an LCD monitor with a system ground unit adapted for electrical connection to a coaxial cable, or a computer with a system ground unit adapted for electrical connection to a network cable. In this embodiment, the signal ground wire 21 of the external device is connected to one terminal 13 of the system ground unit.

Under ground fault conditions, in which electrical current flows through the ground wire 11 and the protective element 14 into the system ground unit, the protective element 14 burns away rapidly, creating a broken circuit state between the ground wire 11 and the system ground unit. Since electrical current flow into the system ground unit is limited, electrical potential of the system ground unit remains stable and equal to an electrical potential of the signal ground wire 21 of the external device. Therefore, electricity leakage through the ground wire 11 and the system ground unit into the signal ground wire 21 is averted, and accompanying risks of overheating and electrical shock are eliminated.

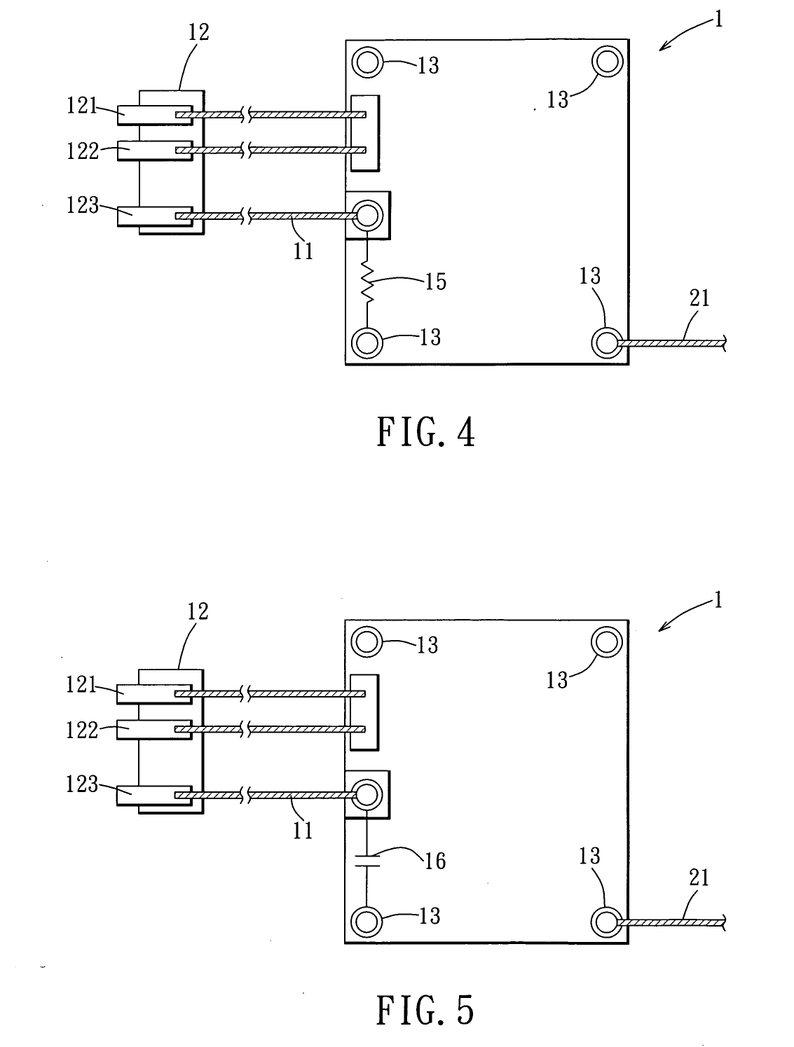

FIG. 4 illustrates a second preferred embodiment of the electronic device 1 with electricity leakage protection according to this invention. This embodiment differs from the first embodiment only in that the protective element 15 that is connected electrically at one end to the ground wire 11 and at the other end to one terminal 13 of the system ground unit is a temperature-sensitive resistor with a positive thermal coefficient (PTC). Under ground fault conditions, heat generated by the flow of electrical current causes the protective element 15 to increase its resistance value, thereby limiting the flow of electrical current into the system ground unit.

FIG. 5 illustrates a third preferred embodiment of an electronic device 1 with electricity leakage protection according to this invention. This embodiment differs from the preceding embodiments only in that the protective element 16 is an isolation capacitor. Under ground fault conditions, the isolation capacitor buffers the electrical signal flowing through the ground wire 11 into the system ground unit.

In sum, the electronic device 1 with electricity leakage protection of the present invention employs the protective element 14,15,16 to isolate the ground wire 11 from the system ground unit in the event of a ground fault, thereby limiting electricity leakage to the system ground unit and the signal ground wire 21, and mitigating fire and shock hazards.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device with electricity leakage protection comprising a ground wire, a system ground unit, and a protective element connected electrically at one end to said ground wire and at another end to said system ground unit, said protective element limiting flow of electrical current through said ground wire into said system ground unit.

2. The electronic device with electricity leakage protection as claimed in claim 1, wherein said system ground unit is adapted for electrical connection to a signal ground wire of an external device, and said protective element limits flow of the electrical current through said ground wire into said system ground unit when said system ground unit is connected electrically to the signal ground wire of the external device.

3. The electronic device with electricity leakage protection as claimed in claim 1, wherein said protective element is one of a fuse, a temperature-sensitive resistor, and an isolation capacitor.

4. The electronic device with electricity leakage protection as claimed in claim 1, further comprising a plug for connecting to an external power source, said plug including a ground prong that is connected electrically to said one end of said protective element via said ground wire.
